(19) United States
(12) Patent Application Publication
(10) Pub. No.: US 2008/0018096 A1
(43) Pub. Date: Jan. 24, 2008

(54) RELEASABLE DOCUMENT AFFIXING ASSEMBLY AND METHOD

(75) Inventor: Gary Steven Kornbluh, Bothell, WA (US)

Correspondence Address: DAVIS WRIGHT TREMAINE, LLP/Seattle, 1201 Third Avenue, Suite 2200, SEATTLE, WA, 98101-3045, US

(73) Assignee: Control Solutions, Inc., Branchburg, NJ (US)

(21) Appl. No.: 11/781,923

(22) Filed: Jul. 23, 2007

Related U.S. Application Data
(60) Provisional application No. 60/820,069, filed on Jul. 21, 2006.

(51) Int. Cl. B42D 15/10; B42D 15/00

(52) U.S. Cl. 283/79; 283/70

(57) ABSTRACT

A releasable document affixing assembly iremovably affixes a document sheet to a container or other object. The method allows for printing, affixing, and removal of the document sheet in few steps. The assembly generally includes two layers: the document sheet and a cover sheet. The document sheet has a first side and a second side that faces the container surface when the assembly is affixed to the container. The second side has a printable surface. The assembly positions the cover sheet as adhering a sticky side of the cover sheet to the first surface of the document sheet, which has a less-stick surface allowing for removal of the cover sheet from the document sheet. Prior to affixing, a border of the document sheet is removed to expose a border of the cover sheet sticky side to adhere the cover sheet to the container surface with the document sheet positioned therebetween.

### BACKGROUND OF THE INVENTION

1. Field of the Invention

The present invention is directed generally to document affixing assemblies.

2. Description of the Related Art

Conventional shipping practices include affixing packing lists, slips, or other documents to an external surface of a package, box, carton or other container to be shipped. One conventional method includes first printing, then folding, and then inserting a document into a plastic sleeve. The plastic sleeve is then affixed by hand to a container by peeling a backing material from the sleeve to expose a sticky surface of the sleeve whereby the sticky surface is adhered to the container. Unfortunately, this conventional method can be time consuming.

A second conventional method uses a paper document that has a first side with a document portion surrounded by a border and a second side typically bearing indicia, such as text, identifying the document such as with the words “packing list.” The document portion can contain shipping information or other alphanumeric or symbolic text. The border includes a backing material that is removed to expose a sticky surface. The first side of the document is pressed against a package, box or other container allowing the sticky border surface to affix the document to the box.

Since the document portion of the document is against the box, the document portion is covered by the document itself. Typically upon the arrival of the container, perforations or face slits are torn to separate the document portion of the document from the document border thereby releasing the document portion of the document from being affixed to the container. Unfortunately, while the document is affixed to the container it is exposed to potential harm, which may occur during the routine steps involved with handling the container during shipping or otherwise.

### BRIEF DESCRIPTION OF THE SEVERAL VIEWS OF THE DRAWING(S)

FIG. 1 is an elevational view of a first side of a document sheet of a releasable document affixing assembly disclosed herein.

FIG. 2 is a elevational view of a second side of the document sheet of FIG. 1.

FIG. 3 is a elevational view of a first side of a cover sheet of the assembly.

FIG. 4 is a elevational view of a second side of the cover sheet of the assembly.

FIG. 5 is a elevational view of a first side of the assembly as sheathed.

FIG. 6 is a elevational view of a second side of the assembly as sheathed.

FIG. 7 is a sectional view of the assembly as sheathed taken along the 7-7 line of FIGS. 5 and 6.

FIG. 8 is a elevational view of a second side of the assembly as unsheathed.

FIG. 9 is a sectional view of the assembly as unsheathed taken along the 9-9 line of FIG. 8.

FIG. 10 is a sectional view of the assembly as unsheathed being affixed to a container shown in fragmentary view.

FIG. 11 is a perspective view of the assembly and a container, the assembly being converted from sheathed to unsheathed for affixing to the container.

FIG. 12 is a perspective view of the assembly and the container, the assembly being unsheathed prior to being affixed to the container of FIG. 11.

FIG. 13 is a perspective view of the assembly affixed to the container of FIG. 11.

FIG. 14 is a perspective view of the assembly affixed to the container of FIG. 11 with the cover sheet in the process of being removed from the container.

FIG. 15 is a perspective view of the cover sheet as separated from the document portion of the document sheet, which is no longer affixed to the container of FIG. 11.

FIG. 16 is a fragmentary elevational view of a roll of sequentially coupled assemblies.

FIG. 17 is a perspective view of the roll of the sequentially coupled assemblies of FIG. 16 being fed through a printer.

FIG. 18 is an elevational view of an alternative version of the document sheet having rounded corners.

FIG. 19 is an elevational view of an alternative version of the document sheet having indicia on the second surface of the document portion.

FIG. 20 is an elevational view of an alternative version of the cover sheet being transparent with the indicia on the cover sheet being removed.

FIG. 21 is an elevational view of an alternative assembly combining the alternative version of the document sheet of FIG. 18 and the alternative version of the cover sheet of FIG. 20.

### DETAILED DESCRIPTION OF THE INVENTION

A releasable document affixing assembly and method is disclosed herein to among other things removably affix a document, such as a packing slip, shipping manifest, invoice, or other document, to a package, box, carton, or other container or object. The method allows for printing, affixing, and removal of the document in few steps. The assembly generally includes two layers: a document sheet and a cover sheet.

The document sheet has a first side that faces away from a container surface and a second side that faces the container surface when the document sheet is affixed to the container. The second side has at least a portion of printable surface material to allow for printing of information such as concerning the container upon which the document sheet will be affixed. The printable surface material may be made of thermal or impact sensitive paper, and could be white or colored. This printable surface material can be printed upon via direct thermal, thermal transfer or impact printing technologies.

In implementations the cover sheet can be transparent or otherwise and can be made from a water resistant material such as a plastic material. The cover sheet has a sticky side coated with an adhesive and a non-sticky side. The assembly positions the cover sheet as removably adhering the sticky adhesive surface side of the cover sheet adjacent to the first surface of the document sheet, which has a less-stick surface allowing for removal of the cover sheet from the document sheet. This less-stick surface can be treated with a non-stick material such as silicone to decrease the ability of the document sheet from sticking to the adhesive on the cover sheet. This allows the document portion of the document sheet to be easily separated from the cover sheet. Prior to affixing, a border of the document sheet is removed thereby exposing a portion of the sticky side of the cover sheet bordering the document sheet. The exposed sticky side of the cover side is then pressed on the container surface thereby adhering the cover sheet to the container surface with the document sheet positioned therebetween.

The less-stick surface of the first surface of the document sheet allows for removal of the cover sheet from the container without damaging the document sheet positioned therebetween. Depending on the user's requirements, for easy or difficult removal from the container, the adhesive can have a selected degree of adhesion as desired. The cover sheet may have one or more tabs, corners, or other portions that are treated or other modified through conventional means to more readily allow for separation from the document sheet and subsequent detachment of the document sheet from the container.

In implementations the document sheet has a document portion that is configured to receive printing from a printer just as being printed on a thermal printer while coupled with the cover sheet for quick on-demand printing, with the cover sheet serving as a durable cover material being advantageous for shipping applications. A printed borderline running along an edge or a notch adjacent an edge of the cover sheet can be used by a printer to determine when a new document sheet has been fed into the printer. Such indication allows a thermal technology printer to determine the beginning and length of a particular instance of the assembly for situations where the particular instance of the assembly is found on a roll of sequentially coupled assemblys. For impact printers, the assembly can be fabricated with tractor feed pins or a friction feed arrangement can be used. Depending on the user's requirements, the size (both width and length) of the document sheet is variable. The document sheet and cover sheet size and material can be matched to the printer's capabilities.

The document sheet has a separating cut such as perforations, or face slits, which are created by running document sheet material under a die. The die creates the face slits by cutting into the document sheet surface without cutting into the cover sheet. The document portion of the document sheet will be created by using face slits to create a rectangle, square or other shape. The corners of the document portion of the document sheet may be rounded, depending on customer preferences, and the type of die used.

A plurality of the assemblies can be provided on a roll with a gap or slit between consecutive cover sheets to allow for easy separation of the consecutive assemblies from one another. Printed indicia, such as text or other symbolic representations, such as “Packing List Enclosed” on the non-sticky side of the cover sheet, can be viewed when the assembly is affixed to the container.

The roll of assemblies can be loaded onto a spindle of a thermal printer, either configured as direct thermal or as thermal transfer with a ribbon. If the printer is configured as direct thermal, the document portion of the document sheet to be printed upon will be thermally sensitive to receive thermal printing. The printer will communicate with one or more external applications, which may include a database and/or a label design program to obtain the variable and static information to be printed, such as customer, shipping address, item descriptions and quantity. Static information, including label format instructions, can be stored within the printer or also be obtained from external applications or databases. The printer will print the required shipping document information on the label area that is enclosed, or outlined, by the face slits. After printing, the assemblies are removed from the printer.

Separation of one of the assemblies from a roll of assemblies can be accomplished with means such as a tear off mechanism or an automatic cutter mechanism on the printer. Alternatively, a separating cut, such as perforations, or face silts between assemblies can be used to assist in easy removal from the roll and the /printer. A user can then peel away a border of the document sheet thereby exposing a sheath portion of the sticky side of the cover sheet while the cover sheet and document portion of the document sheet remain together. The assembly will then be affixed to the container by the exposed border of adhesive of the sticky side of the cover sheet. This adhesive can be of varying characteristics, allowing for easier or more difficult removal, depending on preference.

The applied assembly will travel with the container to its destination. The recipient or other persons will be able to see identification of the assembly contents on the surface of the cover sheet. In implementations the cover sheet will extend over the perimeter edges of the document portion of the document sheet so that the document portion of the document sheet will not run edge to edge with the cover sheet. Consequently, the adhesive on the sheath portion of the sticky side of the cover sheet will make contact with the container to secure the document portion of the document sheet to the container. In some implementations the cover sheet is made from a synthetic, water resistant material to help protect the document portion of the document sheet from the elements.

Detachment of the document sheet from the container can be done by peeling off the cover sheet from the container to allow the document sheet to slide out. For easy removal, a designated portion such as a corner of the cover sheet can have a different characteristic according to conventional teachings to be lifted more easily for peeling away of the cover sheet from the container.

Other implementations print on the document portions of the document sheet by using a printer mechanism attached to an automatic label applicator assembly. In this manner, each of the assemblies is automatically removed from the printer mechanism and applied by the applicator assembly to a desired container without manual intervention.

Another implementation is that pre-printed content information, such as “Packing List Enclosed” is on the surface of the document sheet that is in contact with the cover sheet to be visible through a clear version of the cover sheet. Another implementation includes a plurality of the assemblies consecutively coupled into a fanfold stack.

An illustrative example involves a requirement for a packing slip that is six inches wide by five inches long with an application requiring a thermal printer. The printer can support a document portion of the document sheet with a maximum width of seven inches. The exemplary assembly will be fabricated with a seven inch wide cover sheet and a black borderline sized and positioned to result in a six inch length for the document portion of the document sheet. On the document sheet surface, a die will create a rectangular document portion that is six inches wide by five inches long with the rectangle being centered horizontally on the document sheet and vertically between the black borderline preprinted on the cover sheet.

When a border of the document sheet is peeled from the rest of the document sheet, the cover sheet and a six inch by five inch document portion of the document sheet stay together as an assembly. The separated sheath portion of the document sheet can then be discarded. Since the die centered the face slits for the separating cut, the cover sheet covers the document portion of the document sheet and provides a border that extends a half inch over the edges of the document portion of the document sheet with exposed adhesive. The assembly is then applied to the container. By having adhesive portions of the cover sheet extending over on all its four edges, the document portion of the document sheet is secured to the container and protected from moisture and dirt.

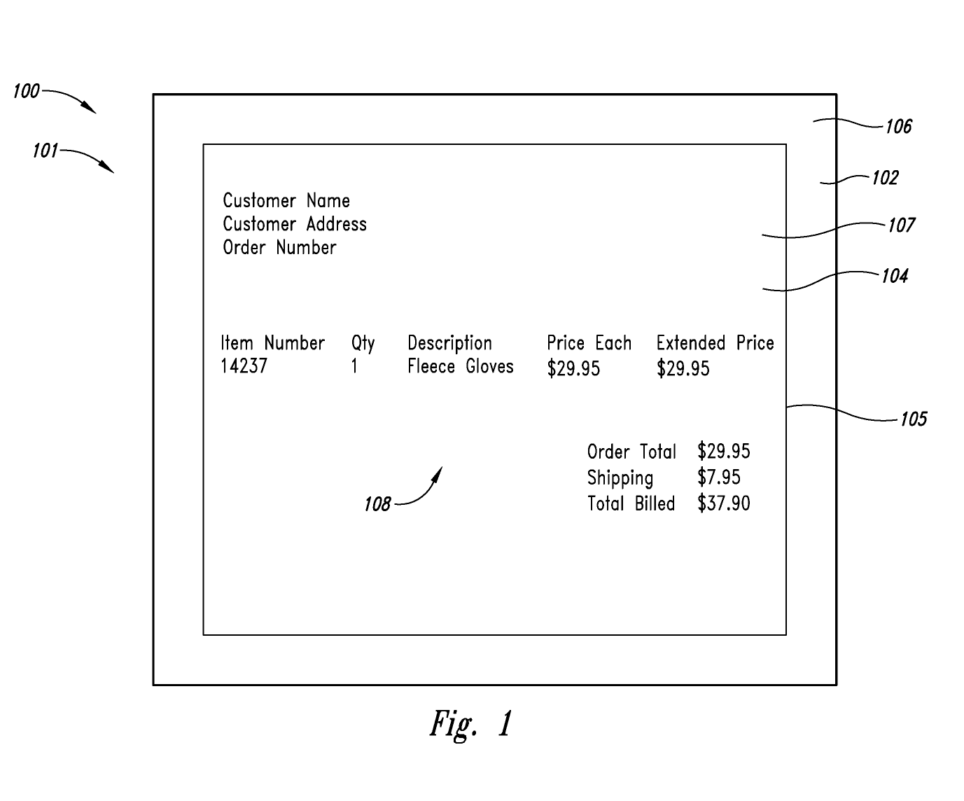

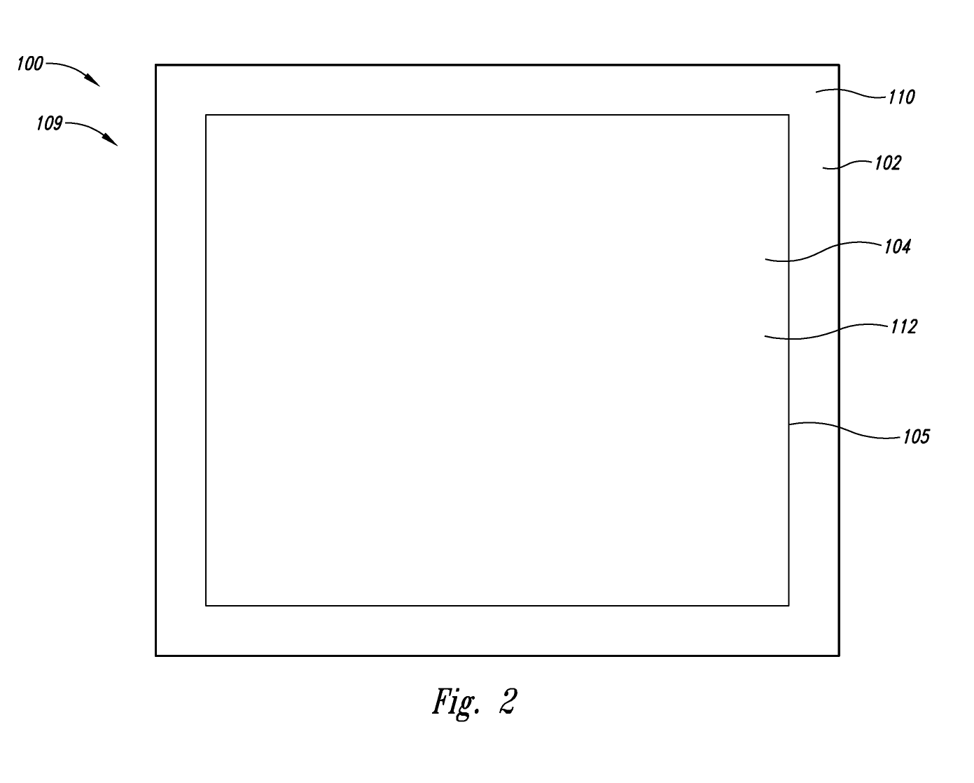

An exemplary document sheet 100 is shown in FIG. 1 as having a first side 101. The document sheet 100 has a sheath portion 102 and a document portion 104 divided therebetween by a separating cut 105 such as scored face slits, perforations, or other sorts around the periphery of the document portion. On the first side 101 of the document sheet 100, the sheath portion 102 has a first surface 106 and the document portion 104 has a first surface 107 with printed text 108. The document sheet 100 is shown in FIG. 2 as having a second side 109. On the second side 109 of the document sheet 100, the sheath portion 102 has a second surface 110 and the document portion 104 has a second surface 112 both of which has less-stick properties caused through material properties of the document sheet or by a desired degree of a non-stick substance being applied to the second side 109.

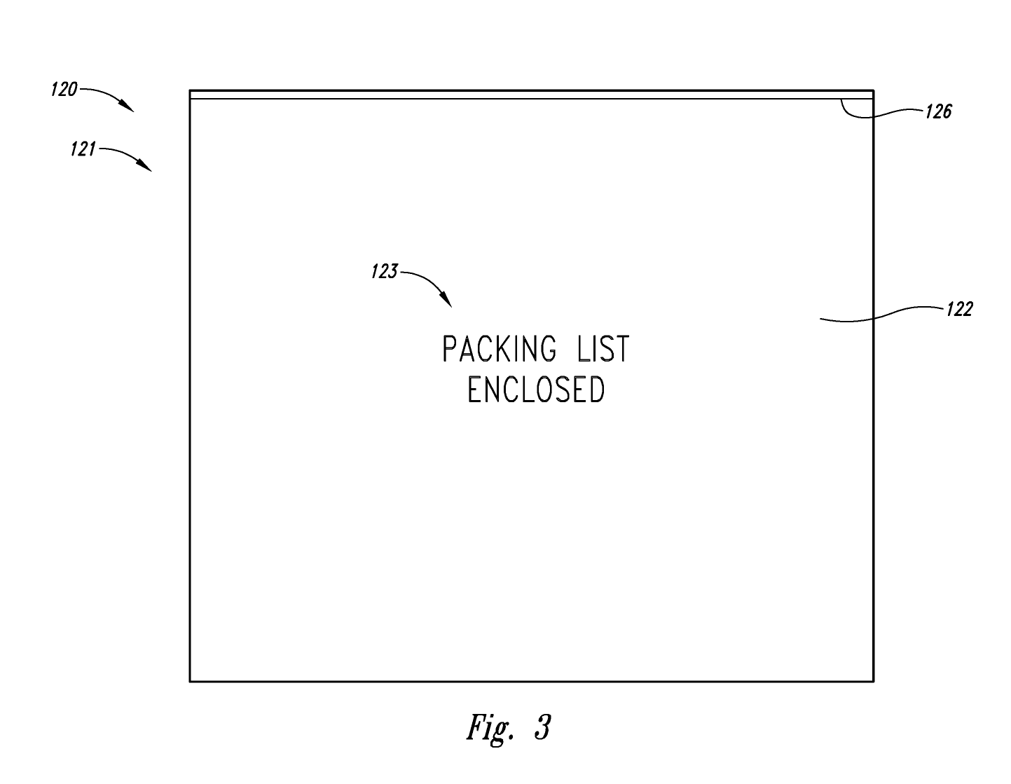

An exemplary cover sheet 120 is shown in FIG. 3 as having a first side 121 with a main surface portion 122 with indicia 123, such as text or other symbolic representations, printed thereon, and a borderline 126 printed thereon and running along an edge of the cover sheet. The cover sheet 120 is depicted as being transparent or semi-transparent, but in other implementations can be opaque. The indicia 123 can be used to identify contents of the document sheet 100, associated with the cover sheet 120 as further discussed herein.

The borderline 126 is can be used by a printer when the cover sheet 120 is with a number of other cover sheets sequentially coupled together as portion of a roll of assemblies as further discussed herein. With the borderline 126 a printer can be configured to determine length of the cover sheet 120 and/or presence of an edge of the cover sheet thereby indicating a beginning or ending of the cover sheet being fed into the printer.

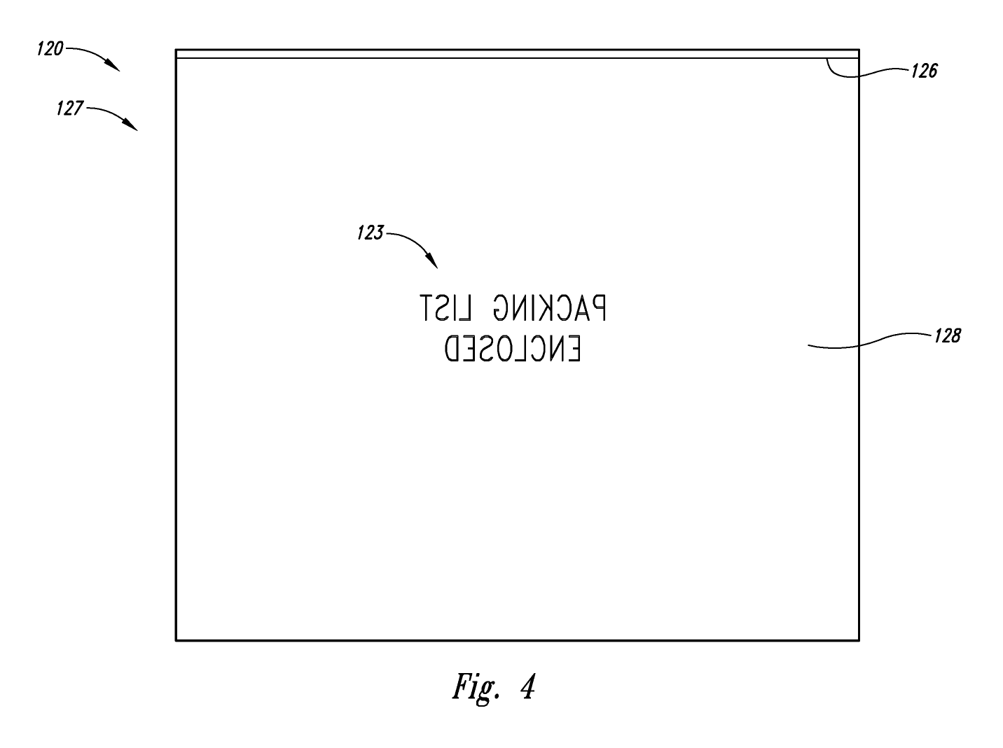

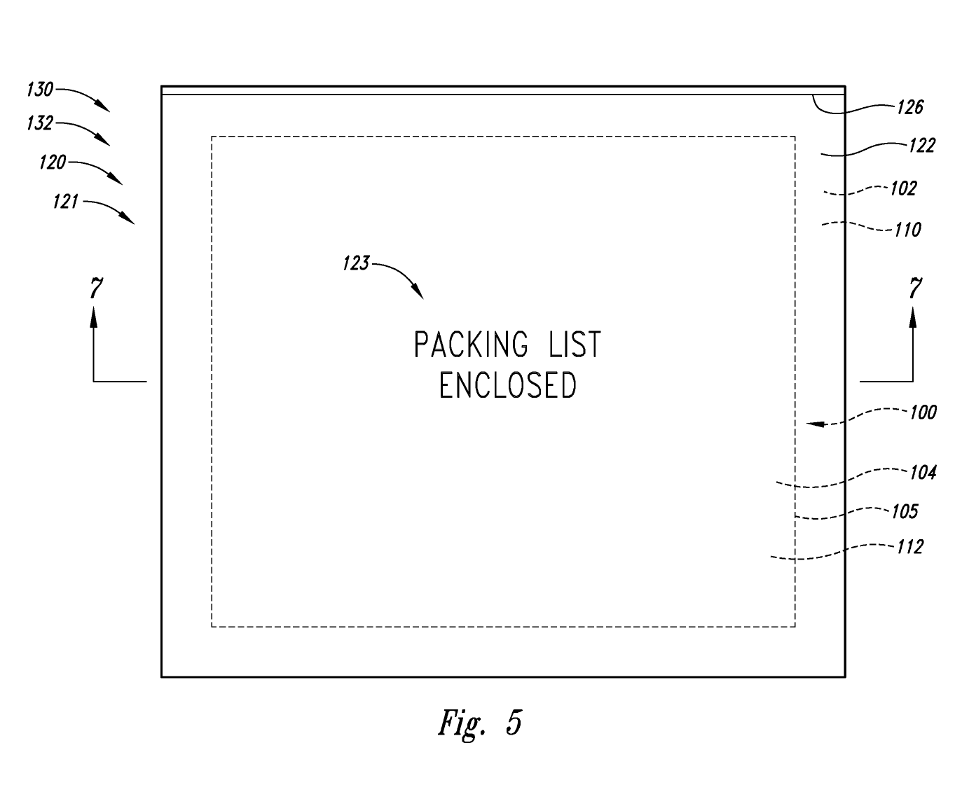

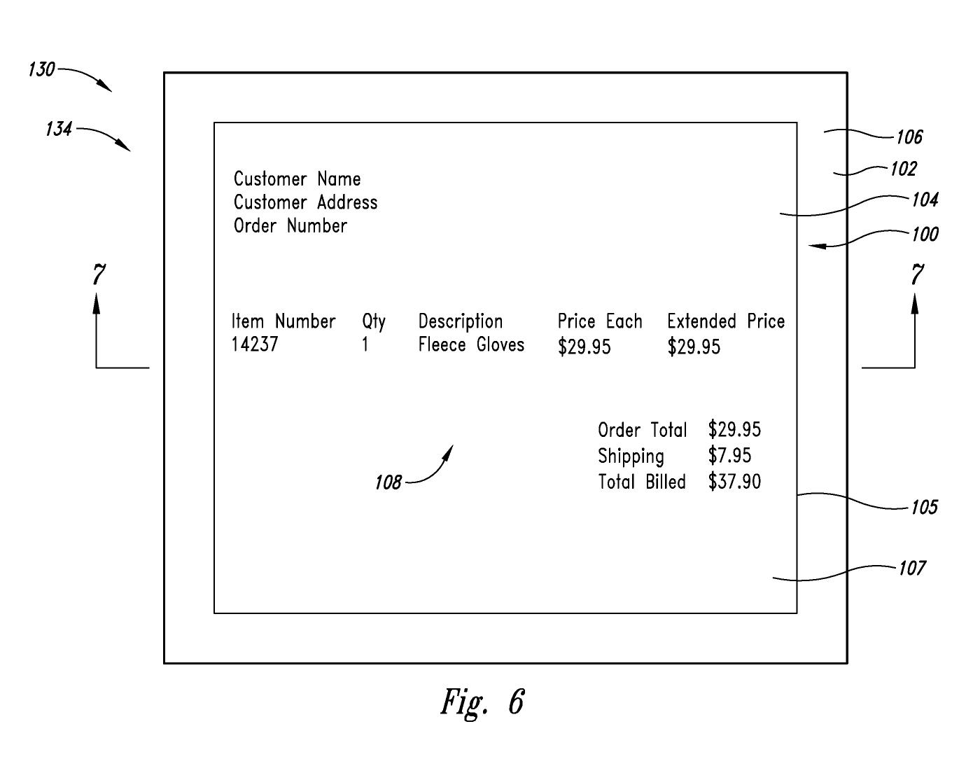

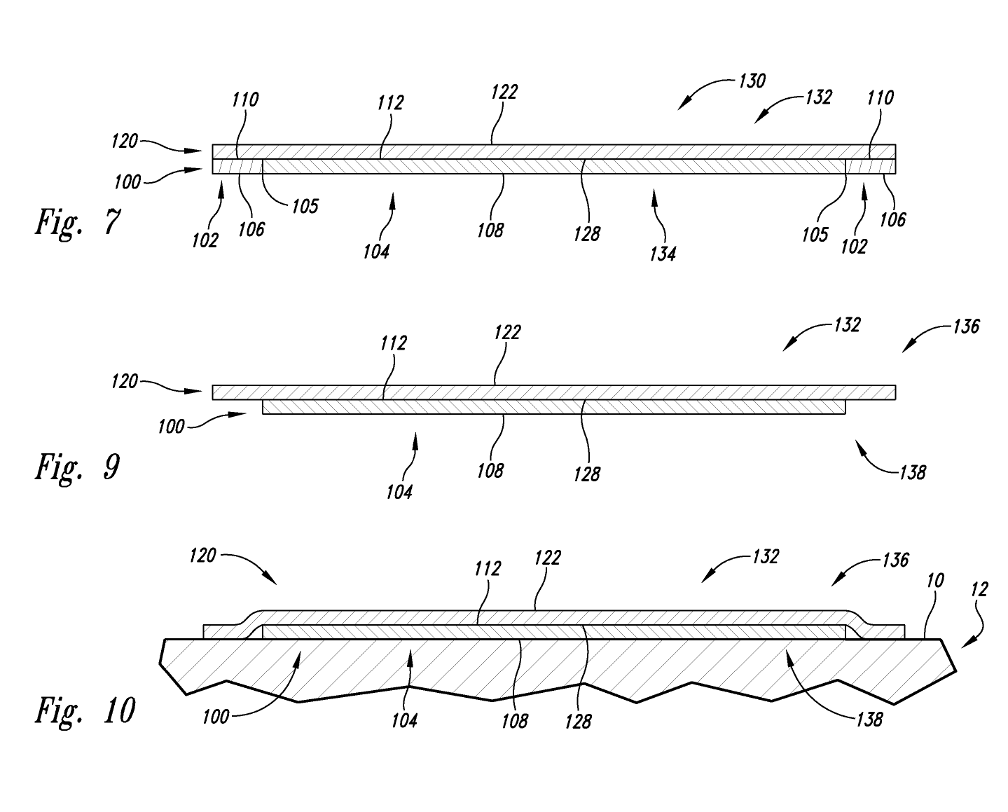

The cover sheet 120 is shown in FIG. 4 as having a second side 127 having a main surface portion 128. The cover sheet 120 is depicted as being transparent or semi-transparent so that the indicia 123 and the borderline 126 is depicted as showing through the cover sheet from the first side 121 of the cover sheet. The main surface portion 128 of the second side 127 of the cover sheet has an adhesive with a selected degree of adhesion so that the surface is sticky. A sheathed assembly 130 having a first side 132 and a second side 134 is shown in FIG. 5 and FIG. 6, respectively. As better shown in FIG. 7, for the sheathed assembly 130, the main surface portion 128 of the second side 127 of the cover sheet 120 is releasably adhering to the second surface 110 of the sheath portion 102 and the second surface 112 of the document portion 104 on the second side 109 of the document sheet 100 through adhesive properties of the second side 127 of the cover sheet 120 and non-stick properties of the second side of the document sheet. The sheathed assembly 130 is designated as sheathed due to the presence of the sheath portion 102 to cover its respective portion of the main surface portion 128 of the second side 127 of the cover sheet 120.

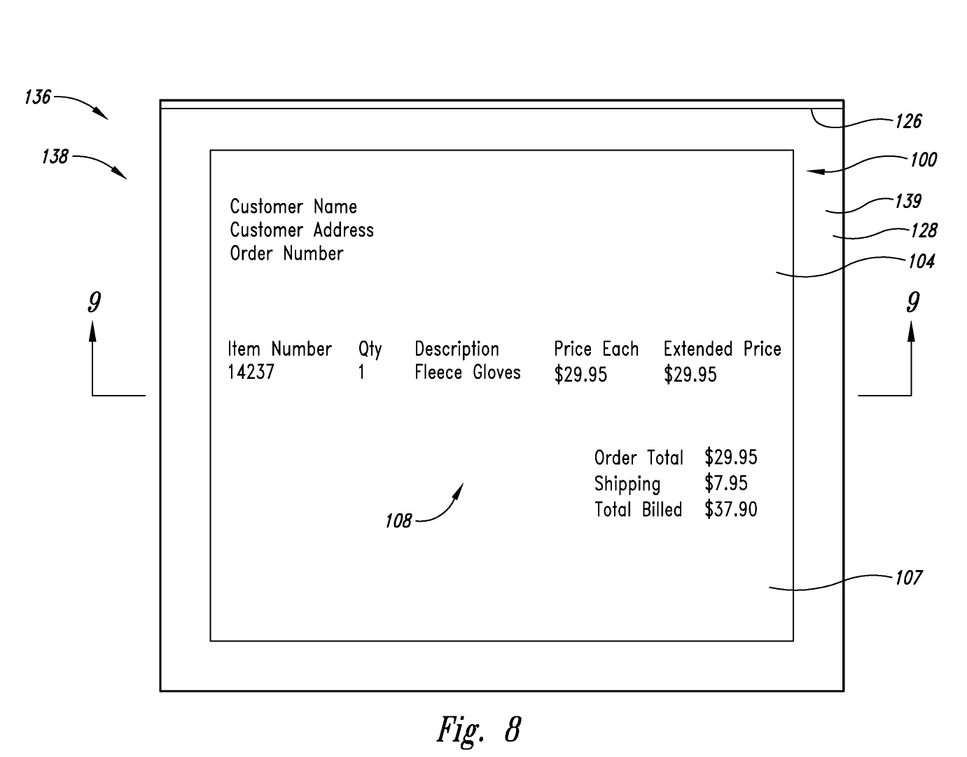

An unsheathed assembly 136 having a second side 138 is shown in FIG. 8 and FIG. 9 with the opposite side of the unsheathed assembly 136 being equivalent to the first side 132 of the sheathed assembly 130. The sheath portion 102 of the document sheet 100 is shown as removed thereby exposing a sheath portion 139 of the main surface portion 128 of the second side 127 of the cover sheet 120. As better shown in FIG. 9, for the unsheathed assembly 130, the main surface portion 128 of the second side 127 of the cover sheet 120 is releasably adhering to only the second surface 112 of the document portion 104 on the second side 109 of the document sheet 100 through adhesive properties of the second side 127 of the cover sheet 120 and non-stick properties of the second side of the document sheet. The unsheathed assembly 130 is designated as unsheathed due to the absence of the sheath portion 102 thereby uncovering and exposing the adhesive properties of the sheath portion 139 of the main surface portion 128 of the second side 127 of the cover sheet 120 to be affixed to a surface 10 of a container 12 as shown in FIG. 10.

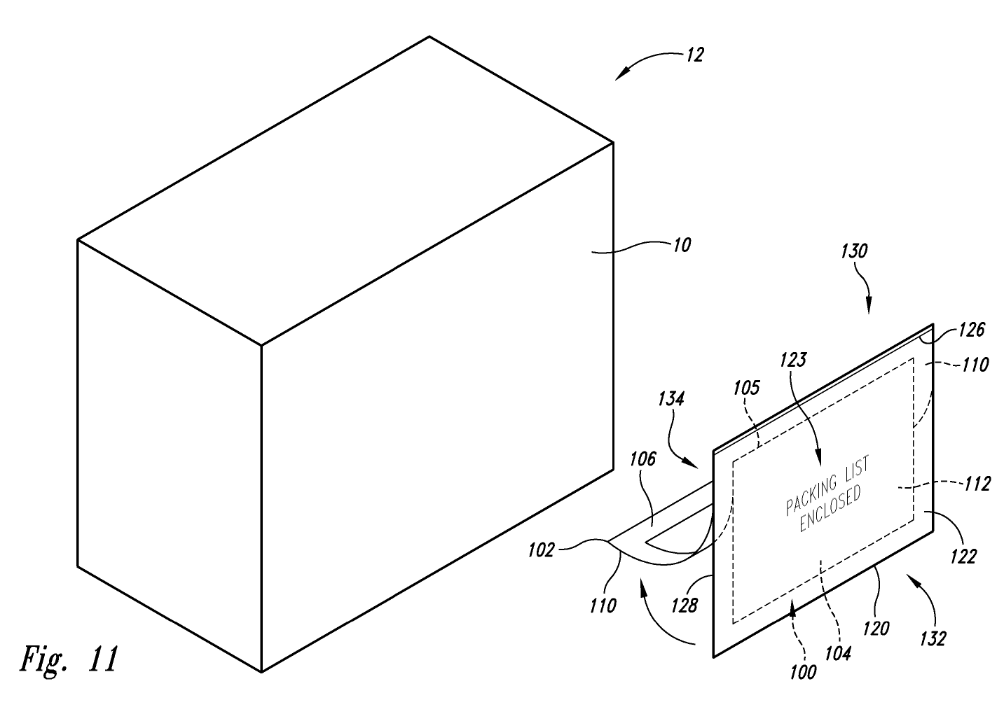

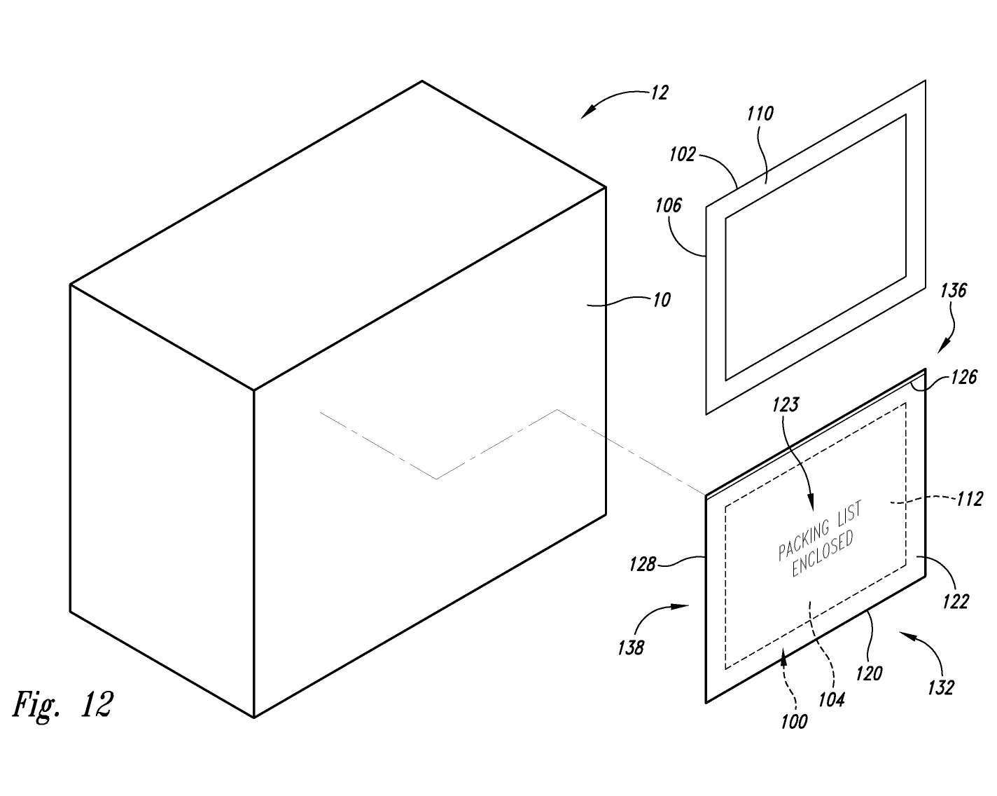

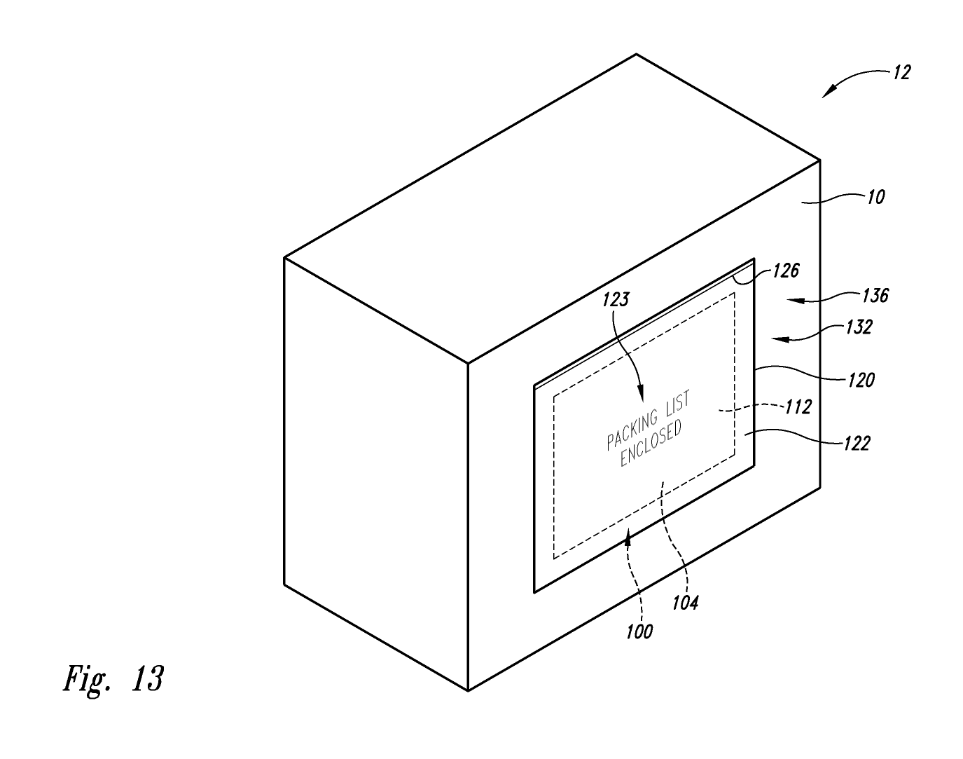

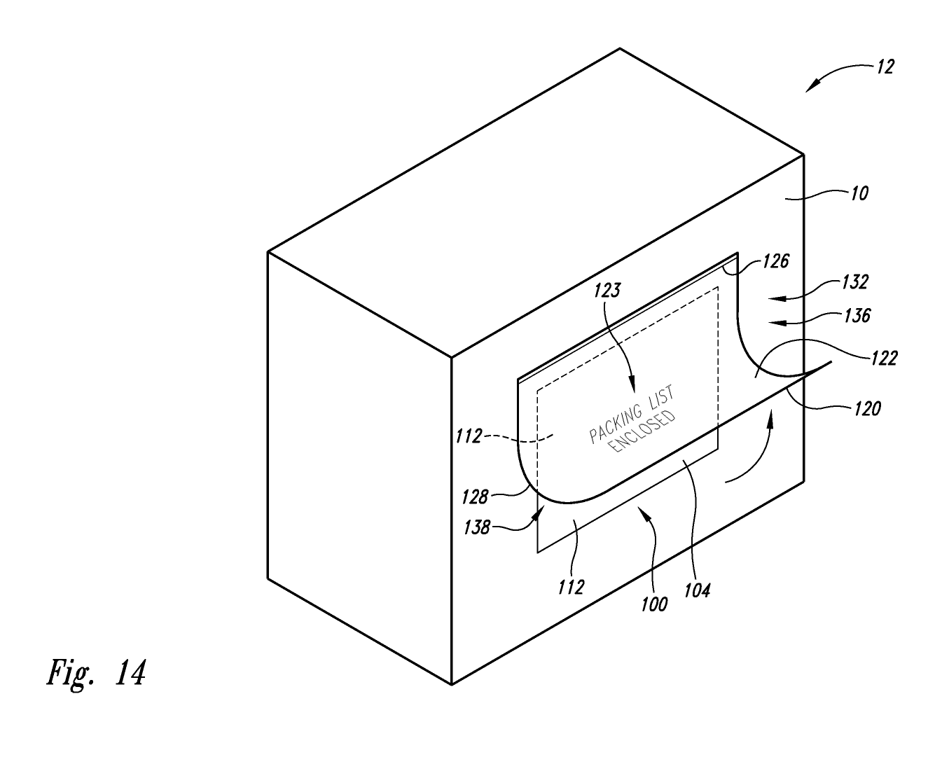

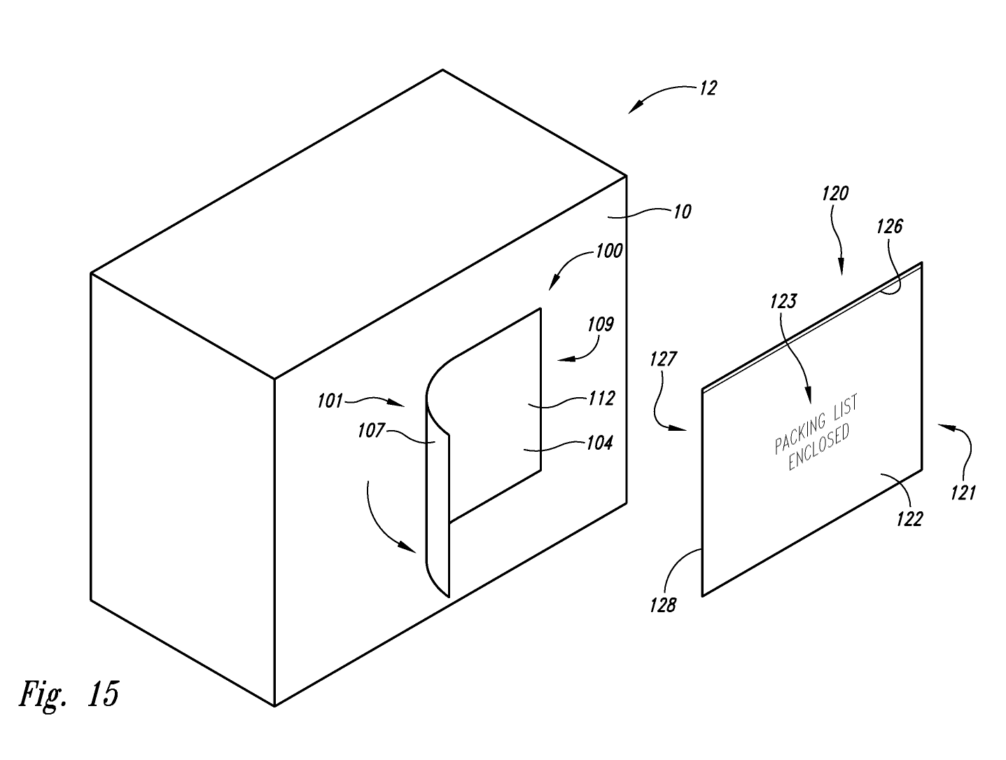

The sheathed assembly 130 is shown in FIG. 11 as in the process of being converted into the unsheathed assembly 136 by removal of the sheath portion 102 of the document sheet 100. FIG. 12 shows completion of removal of the sheath portion 102 thereby exposing the adhesive sheath portion 139 of the main surface portion 128 of the second side 127 of the cover sheet 120. With the adhesive sheath portion 139 exposed, the assembly 130 can be affixed onto a surface 10 of a container 12 as shown in FIG. 13. When the container 12 has reached its shipping destination or for other desirable reasons, the cover sheet 120 can be removed from the container 12, as shown in FIG. 14, thereby detaching the document portion 104 of the document sheet 100 from the container as shown in FIG. 15.

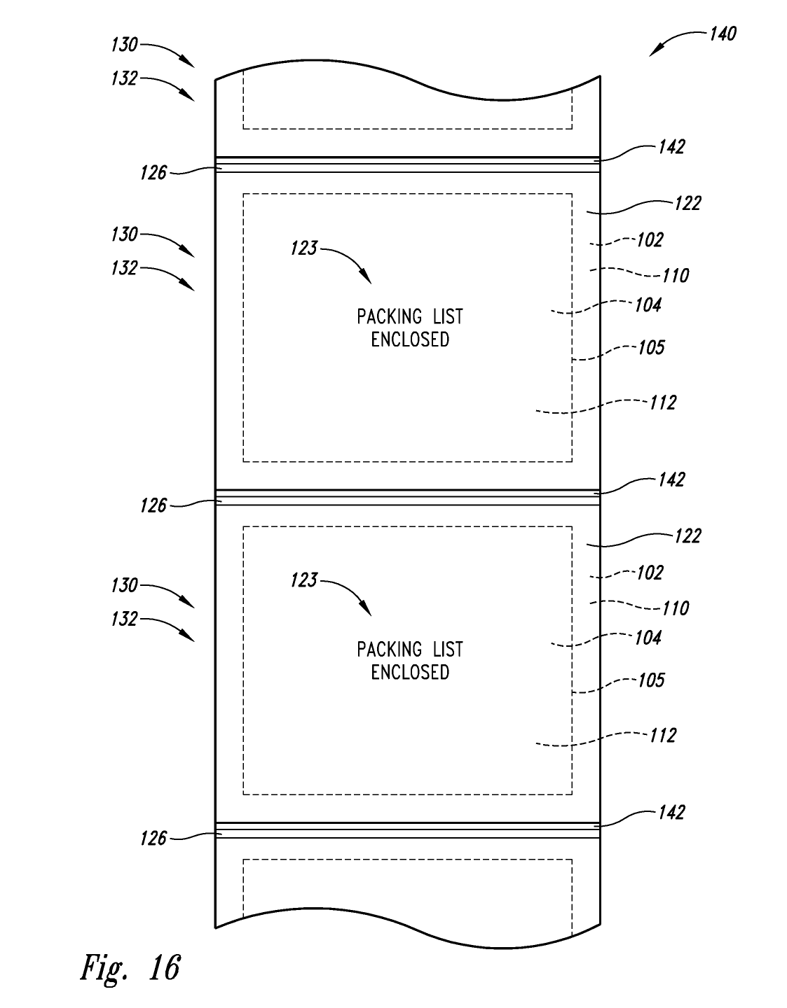

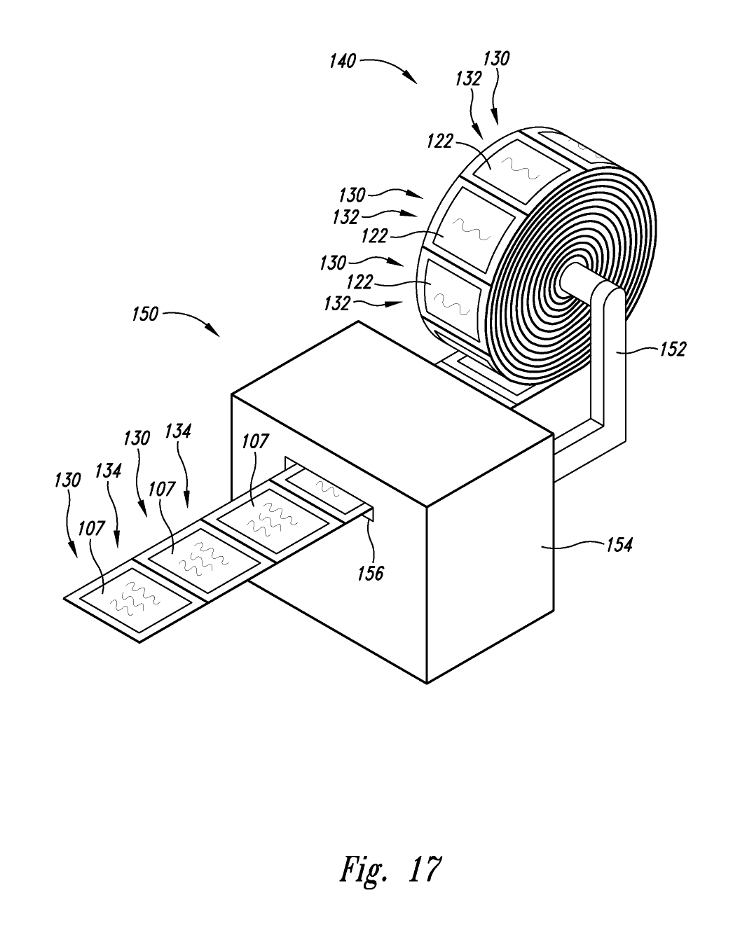

A portion of a roll 140 of sequentially coupled sheathed assemblies 130 is shown in FIG. 16 as having gap portions 142 on the roll positioned between each adjacent pair of sheathed assemblies. The roll 140 is shown in FIG. 17 as part of a printing system 150 in which the roll is coupled to a spindle 152 positioned to feed the roll into a printer 154 for printing onto the first surface 107 of the document portion 104 of the document sheet 100. After being printed upon by the printer 154, each of the sheathed assemblies 130 exit from the printer 154 through the output slot 156, which can have an automatic cutter for serration of the assemblies from one another.

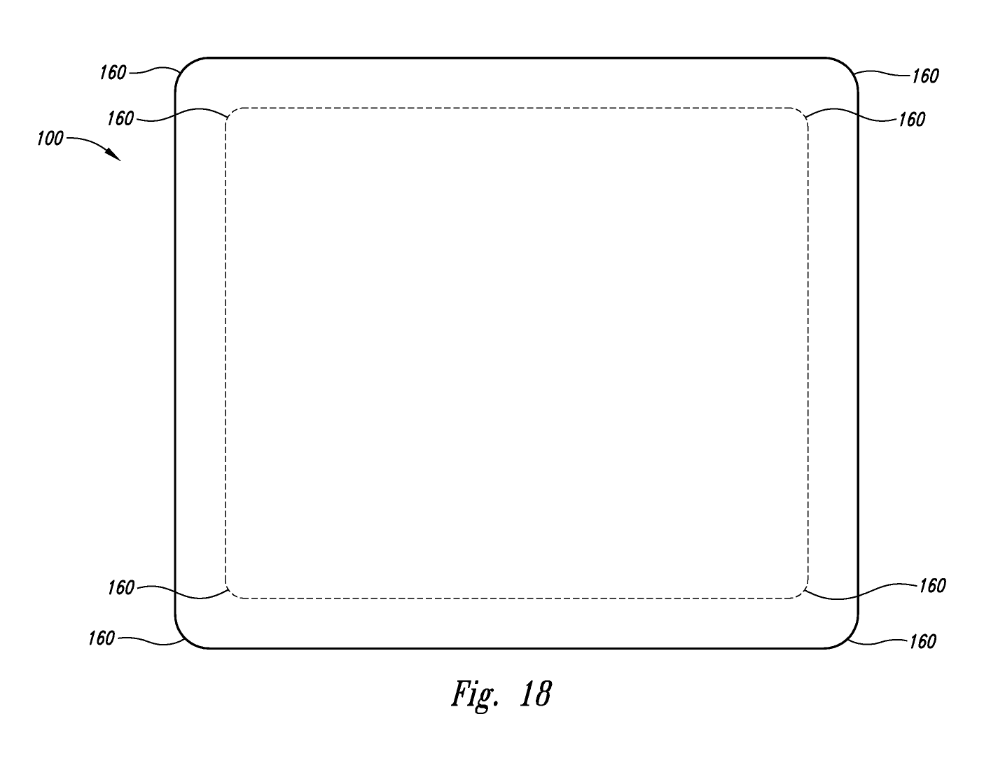

An alternative implementation of the sheath portion 102 and the document portion 104 of the document sheet 100 is shown in FIG. 18 as both having rounded corners 160 to aid in removing the sheath portion from the sheathed assembly 130 and in separating the cover sheet 120 from the document portion 104 of the document sheet in the unsheathed assembly 136.

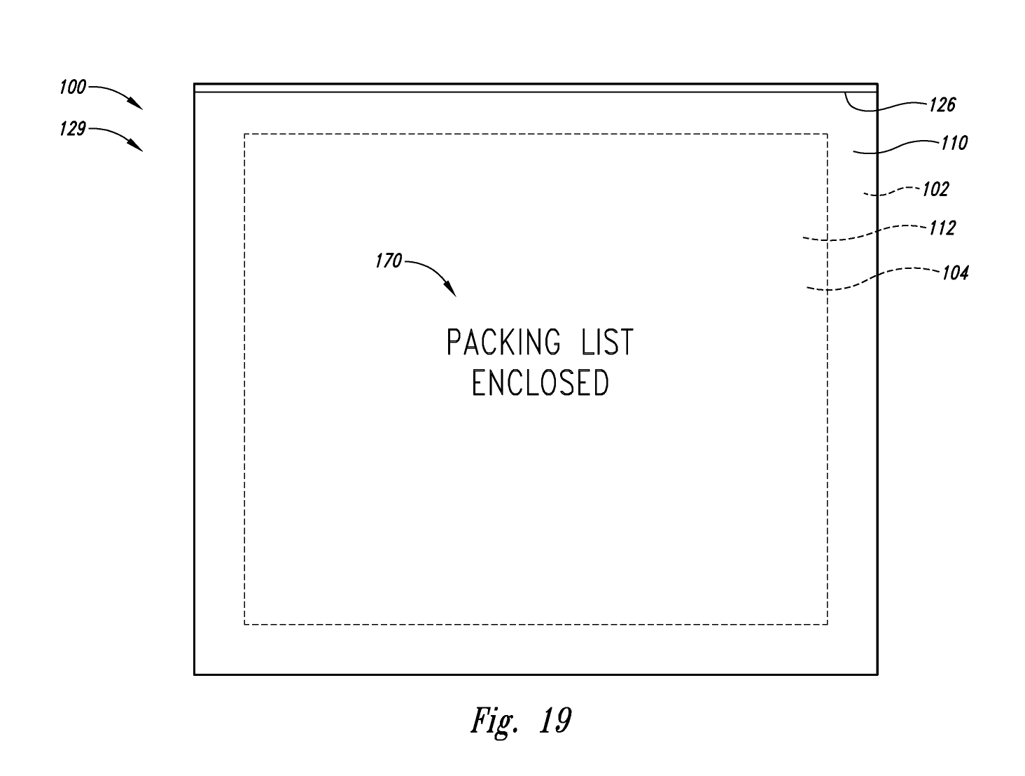

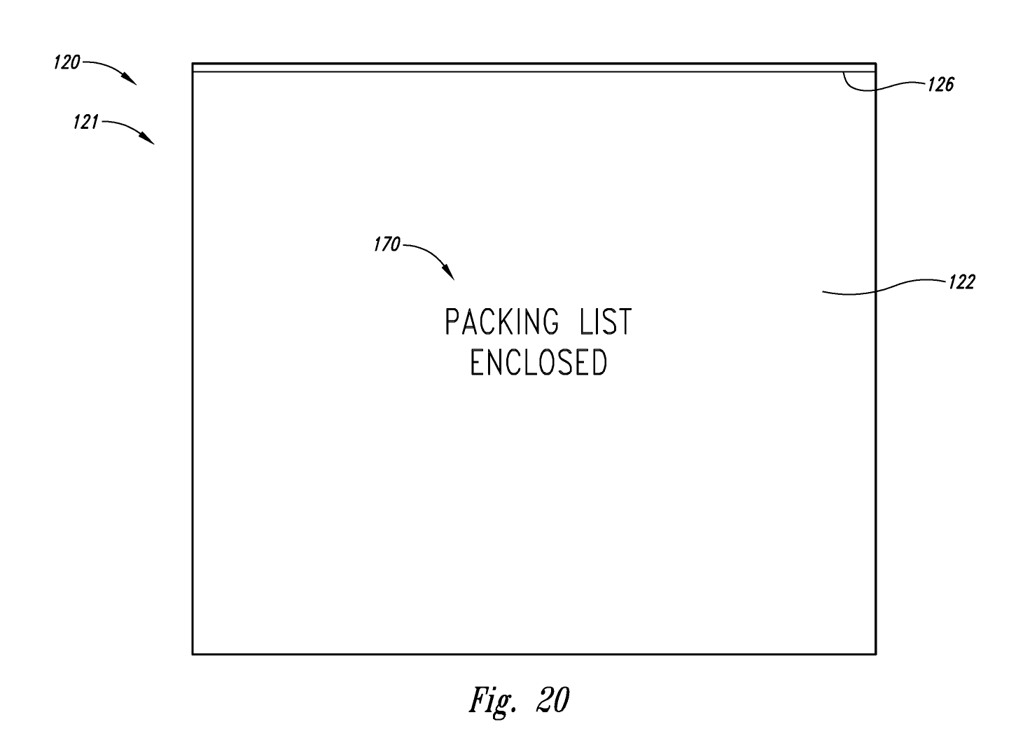

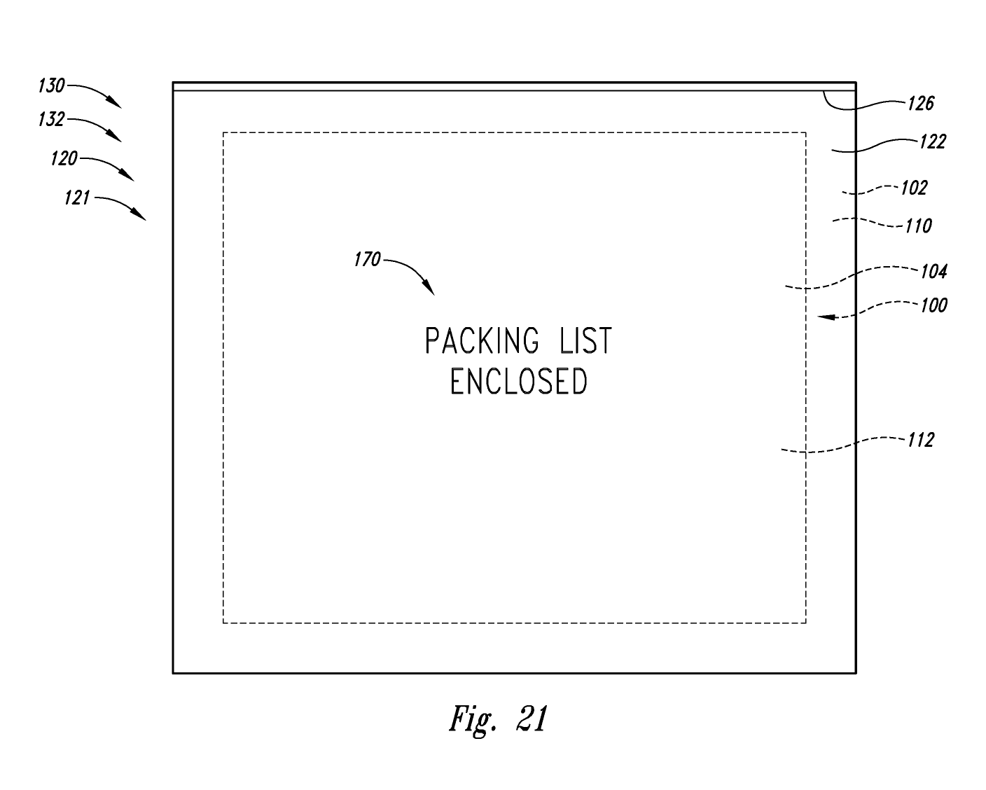

An alternative version of the document sheet 100 having indicia 170 on the second surface of the document portion is shown in FIG. 19. An alternative version of the cover sheet 120 being transparent with the indicia 123 on the cover sheet being removed is shown in FIG. 20. An alternative version of the assembly 130 is shown in FIG. 21 as combining the alternative version of the document sheet 100 of FIG. 18 and the alternative version of the cover sheet 120 of FIG. 20.

Aspects 1. An assembly comprising:

a cover sheet having a first side and a second side, the first side having indicia, the second side having an adhesive surface; and

a document sheet having a document portion and a sheath portion divided by a separating cut, the document portion having a first surface that is printable to receive printing and a second surface, the sheath portion having a first surface and a second surface, the second surface of the document portion and the second surface of the sheath portion being adjacent to and removably adhering to the second side of the cover sheet through the adhesive surface of the second side of the cover sheet.

2. The assembly of aspect 1 wherein the second surface of the document portion and the second surface of the sheath portion having a less-stick property to reduce adhesion by the adhesive surface of the second side of the cover sheet when the second side of the cover sheet is adjacent to the second surface of the document portion and the second portion of the sheath portion.

3. The assembly of aspect 1 wherein the separating cut is at least one of the following: face slits and perforations.

4. The assembly of aspect 1 wherein the second surface of the document portion and the second surface of the sheath portion include a non-stick material.

5. The assembly of aspect 1 wherein the first side of the cover sheet is printable to receive printing.

6. The assembly of aspect 1 wherein the second surface of the document portion and the second surface of the sheath portion include a silicone material.

7. The assembly of aspect 1 wherein the document portion has a periphery and the separating cut and the sheath portion border the periphery.

8. The assembly of aspect 1 wherein the cover sheet is transparent.

9. The assembly of aspect 1 wherein the cover sheet is opaque.

10. The assembly of aspect 1 wherein the cover sheet is semi-transparent.

11. The assembly of aspect 1 wherein the cover sheet is rectangular.

12. The assembly of aspect 1 wherein the document portion of the document sheet is rectangular.

13. The assembly of aspect 1 wherein the cover sheet has rounded corners.

14. The assembly of aspect 1 wherein the first surface of the document portion of the document sheet is thermally sensitive to receive thermal printing.

15. The assembly of aspect 1 wherein the cover sheet overlaps all edges of the document sheet.

16. An assembly comprising:

a cover sheet having a first side and a second side, the cover sheet being transparent, the second side having an adhesive surface; and

a document sheet having a document portion and a sheath portion divided by a separating cut, the document portion having a first surface that is printable to receive printing and a second surface having indicia, the sheath portion having a first surface and a second surface, the second surface of the document portion and the second surface of the sheath portion being adjacent to and removably adhering to the second side of the cover sheet through the adhesive surface of the second side of the cover sheet.

17. An assembly comprising:

a document sheet having a document portion and a sheath portion divided by a separating cut, the document portion having a first surface to receive printing and a second surface having indicia, the sheath portion having a first surface and a second surface; and

a cover sheet having a first side and a second side, the cover sheet being transparent, at least a portion of the second side having an adhesive surface; the second surface of the document portion being adjacent to and removably adhering to a first portion of the second side of the cover sheet, through the adhesive surface of the second side of the cover sheet, the second surface of the sheath portion being adjacent to and removably adhering to a second portion of the second side of the cover sheet through the adhesive surface of the second side of the cover sheet, the adhesive surface of the cover configured to remain adhesive after separation of the sheath portion of the document sheet from the document portion of the document sheet and detachment of the sheath portion of the document sheet from the second side of the cover sheet.

18. An assembly comprising:

a document sheet having a document portion and a sheath portion divided by a separating cut, the document portion having a first surface to receive printing and a second surface, the sheath portion having a first surface and a second surface; and

a cover sheet having a first side and a second side, the first side having indicia, at least a portion of the second side having an adhesive surface; the second surface of the document portion being adjacent to and removably adhering to a first portion of the second side of the cover sheet, through the adhesive surface of the second side of the cover sheet, the second surface of the sheath portion being adjacent to and removably adhering to a second portion of the second side of the cover sheet through the adhesive surface of the second side of the cover sheet, the adhesive surface of the cover configured to remain adhesive after separation of the sheath portion of the document sheet from the document portion of the document sheet and detachment of the sheath portion of the document sheet from the second side of the cover sheet.

19. A roll of consecutively coupled assemblies, each assembly comprising:

a cover sheet having a first side and a second side, the cover sheet being transparent, the second side having an adhesive surface; and

a document sheet having a document portion and a sheath portion divided by a separating cut, the document portion having a first surface that is printable to receive printing and a second surface having indicia, the sheath portion having a first surface and a second surface, the second surface of the document portion and the second surface of the sheath portion being adjacent to and removably adhering to the second side of the cover sheet through the adhesive surface of the second side of the cover sheet.

20. A roll of consecutively coupled assemblies, each assembly comprising:

a document sheet having a document portion and a sheath portion divided by a separating cut, the document portion having a first surface to receive printing and a second surface, the sheath portion having a first surface and a second surface; and

a cover sheet having a first side and a second side, the first side having indicia, at least a portion of the second side having an adhesive surface; the second surface of the document portion being adjacent to and removably adhering to a first portion of the second side of the cover sheet, through the adhesive surface of the second side of the cover sheet, the second surface of the sheath portion being adjacent to and removably adhering to a second portion of the second side of the cover sheet through the adhesive surface of the second side of the cover sheet, the adhesive surface of the cover configured to remain adhesive after separation of the sheath portion of the document sheet from the document portion of the document sheet and detachment of the sheath portion of the document sheet from the second side of the cover sheet.

21. For a surface, a method comprising:

providing a cover sheet having a first side and a second side, the second side having an adhesive surface; and

providing a document sheet having a document portion and a sheath portion divided by a separating cut, the document portion having a first surface that is printable to receive printing and a second surface, the sheath portion having a first surface and a second surface, the second surface of the document portion and the second surface of the sheath portion being adjacent to and removably adhering to the second side of the cover sheet through the adhesive surface of the second side of the cover sheet;

separating the sheath portion of the document sheet from the document portion of the document sheet thereby exposing a first portion of the second side of cover sheet; and

pressing the exposed first portion of the second side of the cover sheet and the first surface of the document portion of the document sheet against the surface against the surface to adhesively engage the first portion of the second side of the cover sheet with a first portion of the surface, the document portion of the document sheet being positioned between a second portion of the second side of the cover sheet and a second portion of the surface.

22. The method of aspect 21 including:

peeling the first portion of the second side of the cover sheet from the first portion of the surface and peeling the second portion of the second side of the cover sheet from the document portion of the document sheet to detach the document portion of the document sheet from the surface.

23. The method of aspect 21 including before providing the cover sheet, printing on the cover sheet.

24. The method of aspect 23 including providing the cover sheet as transparent.

25. The method of aspect 23 wherein the printing on the cover sheet includes printing an indication that a document slip is enclosed.

26. The method of aspect 25 wherein the printing on the cover sheet includes printing an indication that a packing slip is enclosed.

27. The method of aspect 22 including:

before peeling the first portion of the second side of the cover sheet and peeling the second portion of the second side of the cover sheet,, transporting the surface from a first location to a second location.

28. The method of aspect 21 including before separating the sheath portion of the document sheet from the document portion of the document sheet, printing on the first surface of the document portion of the document sheet.

29. The method of aspect 28 wherein the printing on the first surface of the document portion includes printing shipping information.

30. The method of aspect 21 including providing a less-stick property for the second surface of the document portion and the second surface of the sheath portion to reduce adhesion by the adhesive surface of the second side of the cover sheet when the second side of the cover sheet is adjacent to the second surface of the document portion and the second portion of the sheath portion.

31. The method of aspect 21 including providing the second surface of the document portion and the second surface of the sheath portion to include a non-stick material.

32. The method of aspect 21 including providing the first side of the cover sheet as printable to receive printing.

33. The method of aspect 21 including providing the second surface of the document portion and the second surface of the sheath portion to include a silicone material.

34. The method of aspect 21 including providing the document portion of the document sheet to include a periphery and providing the separating cut and the sheath portion of the document sheet to border the periphery of the document portion of the document sheet.

35. The method of aspect 21 including providing the cover sheet as transparent.

36. The method of aspect 21 including providing the cover sheet as opaque.

37. The method assembly of aspect 21 including providing the first surface of the cover as printable to receive printing.

38. The method of aspect 21 including providing the separating cut as at least one of the following: perforations and face slits.

39. The method of aspect 21 including providing the cover sheet as rectangular.

40. The method of aspect 21 including providing the document portion of the document sheet as rectangular.

41. The method of aspect 21 including providing the cover sheet as having rounded corners.

42. The method of aspect 21 including providing the first surface of the document portion of the document sheet as being thermally sensitive to receive thermal printing.

43. The method of aspect 21 including providing the cover sheet as overlapping all edges of the document sheet.

44. For a surface, a method comprising:

providing a document sheet having a document portion and a sheath portion divided by a separating cut, the document portion having a first surface to receive printing and a second surface, the sheath portion having a first surface and a second surface; and

providing a cover sheet having a first side and a second side, at least a portion of the second side having an adhesive surface; the second surface of the document portion being adjacent to and removably adhering to a first portion of the second side of the cover sheet, through the adhesive surface of the second side of the cover sheet, the second surface of the sheath portion being adjacent to and removably adhering to a second portion of the second side of the cover sheet through the adhesive surface of the second side of the cover sheet, the adhesive surface of the cover configured to remain adhesive after separation of the sheath portion of the document sheet from the document portion of the document sheet and detachment of the sheath portion of the document sheet from the second side of the cover sheet;

separating the sheath portion of the document sheet from the document portion of the document sheet thereby exposing a first portion of the second side of cover sheet; and

pressing the exposed first portion of the second side of the cover sheet and the first surface of the document portion of the document sheet against the surface against the surface to adhesively engage the first portion of the second side of the cover sheet with a first portion of the surface, the document portion of the document sheet being positioned between a second portion of the second side of the cover sheet and a second portion of the surface.

45. For a surface, a method comprising:

providing a plurality of consecutively coupled assemblies, each assembly comprising:
a cover sheet having a first side and a second side, the second side having an adhesive surface; and
a document sheet having a document portion and a sheath portion divided by a separating cut, the document portion having a first surface that is printable to receive printing and a second surface, the sheath portion having a first surface and a second surface, the second surface of the document portion and the second surface of the sheath portion being adjacent to and removably adhering to the second side of the cover sheet through the adhesive surface of the second side of the cover sheet;

separating a first one of the assemblies from the plurality of assemblies; and

for the first one of the assemblies,
separating the sheath portion of the document sheet from the document portion of the document sheet thereby exposing a first portion of the second side of cover sheet; and
pressing the exposed first portion of the second side of the cover sheet and the first surface of the document portion of the document sheet against the surface against the surface to adhesively engage the first portion of the second side of the cover sheet with a first portion of the surface, the document portion of the document sheet being positioned between a second portion of the second side of the cover sheet and a second portion of the surface.

46. The method of aspect 45 including before separating the sheath portion of the document sheet for the first one of the assemblies from the document portion of the document sheet, printing on the first surface of the document portion of the document sheet.

47. The method of aspect 45 wherein providing the plurality of assemblies includes providing the assemblies as part of a roll.

48. The method of aspect 45 wherein providing the plurality of assemblies includes providing the assemblies as part of a fanfold.

49. The method of aspect 48 wherein the printing includes using a sensor to sense a borderline between two of the assemblies.

50. The method of aspect 48 wherein the printing includes using a sensor to sense a notch between two of the assemblies.

51. The method of aspect 48 wherein the printing includes thermal printing.

52. The method of aspect 48 wherein the printing includes use of a ribbon.

53. The method of aspect 48 wherein the printing includes use of a database.

54. The method of aspect 53 including after printing on the first surface of the document portion of the document sheet for the first one of the assemblies, separating the first one of the assemblies from the others of the plurality of the assemblies with an automatic cutting mechanism.

55. The method of aspect 53 including after printing on the first surface of the document portion of the document sheet for the first one of the assemblies, separating the first one of the assemblies from the plurality of the assemblies by manually tearing the first one of the assemblies from the others of the plurality of the assemblies.

56. The method of aspect 55 including providing the plurality of consecutively coupled assemblies with a gap between each pair of consecutively coupled assemblies wherein the manually tearing involves the gap.

57. The method of aspect 55 including providing the plurality of consecutively coupled assemblies with perforations between each pair of consecutively coupled assemblies wherein the manually tearing involves the perforations.

From the foregoing it will be appreciated that, although specific implementations have been described herein for purposes of illustration, various modifications may be made without deviating from the spirit and scope of the invention.

The invention claimed is:

1. For a surface, a method comprising:
providing a cover sheet having a first side and a second side, the second side having an adhesive surface;
providing a document sheet having a document portion and a sheath portion divided by a separating cut, the document portion having a first surface that is printable to receive printing and a second surface, the sheath portion having a first surface and a second surface, the second surface of the document portion and the second surface of the sheath portion being adjacent to and removably adhering to the second side of the cover sheet through the adhesive surface of the second side of the cover sheet;
providing indicia to be viewed from the second side of the cover;
separating the sheath portion of the document sheet from the document portion of the document sheet thereby exposing a first portion of the second side of cover sheet; and
pressing the exposed first portion of the second side of the cover sheet and the first surface of the document portion of the document sheet against the surface to adhesively engage the first portion of the second side of the cover sheet with a first portion of the surface, the document portion of the document sheet being positioned between a second portion of the second side of the cover sheet and a second portion of the surface.

2. The method of claim 1 including:
peeling the first portion of the second side of the cover sheet from the first portion of the surface and peeling the second portion of the second side of the cover sheet from the document portion of the document sheet to detach the document portion of the document sheet from the surface.

3. The method of claim 1 including before providing the cover sheet, printing on the cover sheet.

4. The method of claim 3 wherein the printing on the cover sheet includes printing an indication that a document slip is enclosed.

5. The method of claim 2 including:
before peeling the first portion of the second side of the cover sheet and peeling the second portion of the second side of the cover sheet, transporting the surface from a first location to a second location.

6. The method of claim 1 including before separating the sheath portion of the document sheet from the document portion of the document sheet, printing on the first surface of the document portion of the document sheet.

7. The method of claim 6 wherein the printing on the first surface of the document portion includes printing shipping information.

8. The method of claim 1 including providing a less-stick property for the second surface of the document portion and the second surface of the sheath portion to reduce adhesion by the adhesive surface of the second side of the cover sheet when the second side of the cover sheet is adjacent to the second surface of the document portion and the second portion of the sheath portion.

9. The method of claim 1 including providing the separating cut as at least one of the following: perforations and face slits.

10. The method of claim 1 including providing the first surface of the document portion of the document sheet as being thermally sensitive to receive thermal printing.

11. The method of claim 1 including providing the cover sheet as overlapping all edges of the document sheet.

12. The method of claim 1 further including removing the cover sheet from the surface to access the document portion of the document sheet.

13. For a surface of a container, a method comprising:
providing a document sheet having a document portion and a sheath portion divided by a separating cut, the document portion having a first surface to receive printing and a second surface, the sheath portion having a first surface and a second surface; and
providing a cover sheet having a first side and a second side, at least a portion of the second side having an adhesive surface; the second surface of the document portion being adjacent to and removably adhering to a first portion of the second side of the cover sheet, through the adhesive surface of the second side of the cover sheet, the second surface of the sheath portion being adjacent to and removably adhering to a second portion of the second side of the cover sheet through the adhesive surface of the second side of the cover sheet, the adhesive surface of the cover configured to remain adhesive after separation of the sheath portion of the document sheet from the document portion of the document sheet and detachment of the sheath portion of the document sheet from the second side of the cover sheet;
separating the sheath portion of the document sheet from the document portion of the document sheet thereby exposing a first portion of the second side of cover sheet; and
pressing the exposed first portion of the second side of the cover sheet and the first surface of the document portion of the document sheet against the surface of the container to adhesively engage the first portion of the second side of the cover sheet with a first portion of the surface, the document portion of the document sheet being positioned between a second portion of the second side of the cover sheet and a second portion of the surface.

14. The method of claim 13 further including removing the cover sheet from the surface of the container to access the document portion of the document sheet.

15. For a surface of a container, a method comprising:
providing a plurality of consecutively coupled assemblies, each assembly comprising:
a cover sheet having a first side and a second side, the second side having an adhesive surface; and
a document sheet having a document portion and a sheath portion divided by a separating cut, the document portion having a first surface that is printable to receive printing and a second surface, the sheath portion having a first surface and a second surface, the second surface of the document portion and the second surface of the sheath portion being adjacent to and removably adhering to the second side of the cover sheet through the adhesive surface of the second side of the cover sheet;
separating a first one of the assemblies from the plurality of assemblies; and
for the first one of the assemblies,
separating the sheath portion of the document sheet from the document portion of the document sheet thereby exposing a first portion of the second side of cover sheet; and
pressing the exposed first portion of the second side of the cover sheet and the first surface of the document portion of the document sheet against the surface of the container to adhesively engage the first portion of the second side of the cover sheet with a first portion of the surface, the document portion of the document sheet being positioned between a second portion of the second side of the cover sheet and a second portion of the surface.

16. The method of claim 15 including before separating the sheath portion of the document sheet for the first one of the assemblies from the document portion of the document sheet, printing on the first surface of the document portion of the document sheet.

17. The method of claim 15 wherein providing the plurality of assemblies includes providing the assemblies as part of a roll.

18. The method of claim 15 including providing the plurality of consecutively coupled assemblies with a gap between each pair of consecutively coupled assemblies and using the gap to separate the pair.

19. The method of claim 15 further including removing the cover sheet from the surface of the container to access the document portion of the document sheet.

20. An assembly comprising:
a cover sheet having a first side and a second side, the first side having indicia, the second side having an adhesive surface; and
a document sheet having a document portion and a sheath portion divided by a separating cut, the document portion having a first surface that is printable to receive printing and a second surface, the sheath portion having a first surface and a second surface, the second surface of the document portion and the second surface of the sheath portion being adjacent to and removably adhering to the second side of the cover sheet through the adhesive surface of the second side of the cover sheet.
